(19) United States
(12) Patent Application Publication
(10) Pub. No.: US 2008/0229376 A1
(43) Pub. Date: Sep. 18, 2008

(54) COMPREHENSIVE SYSTEM FOR BROADCAST INFORMATION CAPTURE AND ACCESS FOR DATA MINING PURPOSES

(76) Inventor: Eldad SAYADA, Petach Tikva (IL)

Correspondence Address: Shiboleth, Yisraeli, Roberts, Zisman & Co., Suite 2527, 1 Penn Plaza, New York, NY, 10119, US

(21) Appl. No.: 11/752,959

(22) Filed: May 24, 2007

Related U.S. Application Data
(60) Provisional application No. 60/894,699, filed on Mar. 14, 2007.

(51) Int. Cl. H04N 7/173

(52) U.S. Cl. 725/110

(57) ABSTRACT

A system to enable comprehensive capture of broadcast media information comprising video, audio and text content. The system includes a plurality of antennas to receive a plurality of channels in one location, a channel splitter to split the plurality of channels, a plurality of receivers, each to receive and decode either one channel or a group of channels simultaneously. The system also includes a storage network to archive the previously received broadcast media information content within the plurality of channels and a common Web browser to provide “on the spot” retrieving of airing statistics related to broadcast media information content, such that live analysis of the broadcast media information content of the plurality of channels is enabled.

### FIELD OF THE INVENTION

The present invention generally relates to broadcast information processing, and more particularly, to a comprehensive system for broadcast information capture and access for data mining purposes.

### BACKGROUND OF THE INVENTION

Current services provide only a limited number of statistics regarding broadcast information content. These statistics are limited to a basic analysis of commercial spots. These existing services do not provide online analyses, do not offer a comprehensive view of the data, nor do they supply full geographic coverage of the U.S. television broadcast market. Despite these shortcomings, these companies have enjoyed overwhelming demand.

Today, television broadcasters manage their own content, each individually and independently, by storing all or most programs on tapes or some other form of backup device. Content is then cataloged using general information parameters such as type of program, title, airing time, duration, etc. Indexing of the tapes is sometimes performed automatically though a database management program, very similar to the ones used in libraries. However, apart from watching every tape carefully, and then painstakingly taking minutes of, or “logging” the script, broadcasters have no way of tracing details of program content. Furthermore, it is impossible to automatically compare content between several tapes. Although technological advances have provided better storage devices, the painstaking process of tracing content remains manual and error prone.

There are a number of companies in the U.S. broadcast market providing TV media research. The main players in this arena are: ConfirMedia, CMR, and Nielsen. Nielsen Media Research identifies TV viewing patterns using a selected panel of viewers; as such their primary aim is not to trace TV exposure. However, Nielsen Advertiser Services, part of the Media Research group, provides information services in the field of commercial tracking and verification. They also create special reports on customers' advertising programs and competitive activity. The total revenue of Nielsen Global was estimated at 11 billion dollars in 2002.

All three companies either use a digital watermark that is attached to the ad in order to facilitate tracking or use a set-top box that requires installation of special equipment and authorization from the viewer. This technology cannot guarantee absolute accuracy, since the broadcasters, who may not want to allow exact indexing of their commercial airing parameters, can remove the watermark. The practice of removing digital watermarks occurs all too frequently. As a result, this method is inaccurate, providing potentially misleading information to the client.

Additionally, ConfirMedia, Nielsen Advertiser Services and CMR price their “broadcast verification services” per spot and per campaign.

There are currently more than 300,000 songwriters, composers and music publisher affiliates (BMI sources). When a producer wants to use an existing song in a weekly TV series, special, mini-series, or made-for-TV movie, permission must, with few exceptions, be secured from the song's publisher. Nevertheless, how can that rule be enforced considering the width and depth of the total US broadcast market? Some companies use watermark encoding on audio content to trace airing of songs on radio or TV, but the process is unreliable, especially when only parts of a song are played.

### Advertising-PR Agencies and Their Clients

The Association of National Advertisers (ANA) and the American Association of Advertising Agencies (AAAA) have established the need for a new coding system, in order to gain greater control and more accurately manage ad campaigns. The associations have issued contracts to develop a new digital code, which should be launched in the near future. However, as illustrated in a previous section, coding technologies have not matured significantly and are still subject to removal techniques. In fact, there is no certainty that the new code implementation will lead to significant improvements in tracing, tracking or controlling broadcast advertising.

It is clear that advertising agencies could save their clients' time and money with “in-flight” anomaly detection and powerful, accurate reporting. Ready-to-use analytic information would facilitate immediate identification and provide the agencies with the following benefits:
Reduce invoice discrepancy at month's end with Daily In-Flight Discrepancy Management.
Identify double spotting conflicts between national and local schedules. Deliver 3rd-party broadcast auditing to clients.
Provide broadcast schedule data formatted for research, marketing, and modeling analysis activities.
Answer client broadcast airing queries in moments, rather than days.
ConfirMedia issued publications stating the estimated evaluation of the U.S. broadcast advertising industry to be $90 billion a year.

Several years ago, production workflows were much more linear than they are today. News feed would come into a facility, someone in the tape room would record the feed, an editor would pick up the tape and begin editing and, finally, the completed story would be delivered to the control room for integration into the evening news. Then, if the story were particularly important, someone would put it on a shelf in the library and perhaps catalog its location for later retrieval.

Technology has enabled major changes to this workflow. In new workflows, the archive serves as a central repository for content, and the system allows people to quickly locate the material they need. Several editors can work on the same source material at the same time to create different products. For example, a producer may send a particularly important news story directly to air as it arrives from the field. At the same time, the system feeds the material into a central repository. Editors begin creating rough-cut stories from the incoming feed almost immediately. Taped pieces begin appearing within a few minutes. As this is happening, different groups of editors may have already begun working on pieces for the 6:00 p.m. and 11:00 p.m. news.

Many people may want access to the same content at the same time. This was difficult to do when editing systems were primarily tape-based. However, as one moves to digital networked editing environments, it becomes possible for the user to change from a linear workflow to a more collaborative environment. Once material is stored on a server and different groups begin putting various completed pieces back on the server, some sort of content tracking system becomes critical. That is the function of a system—to keep track of where content is located and help users find it.

Multimedia asset-management systems help the user to locate content. In theory, media asset management systems have been a part of broadcast operations for years. In actuality, the first media asset management systems were file cards. As content grew, broadcasters and post-production facilities began to use computers to track material in their archives. The archive was viewed as an end-of-pipe process, and multi media asset management systems were largely confined to simple catalog systems.

Media asset management systems have evolved significantly, and the role of the archive has changed dramatically. Media asset management systems now can locate and track content throughout a facility. Broadcasters have created a new category of archived, shared-content storage that often operates at the center of networked production facilities.

The Metadata

A dilemma facing media asset management systems is how to obtain metadata such as cataloging information and annotations. It is one thing to go to a search engine on the Web, type in a word or phrase and have hundreds of likely Web pages appear. Search engines parse text to build databases that yield quick search results. It is quite another thing to search through video content.

The dilemma for video is simple to explain, but difficult to resolve. Who do you designate to watch movies or news stories and type in the information that others will later use to retrieve the video or audio. If an organization already has an archive, it is likely that someone there is familiar with its contents. If the volume of new material entering the archive is low, then it may be possible for this person to enter detailed information on a scene-by-scene basis. However, many larger organizations face a difficult task, either because they have large amounts of new material coming into their facilities or because they have a huge backlog of material waiting to be cataloged. In either case, any single individual is not capable of doing this for long periods and a “team” of loggers becomes unreliable and expensive.

The only solution to resolve this dilemma is to use advanced database technologies and implement them within a system, which also captures the relevant broadcast data.

Thus it would be advantageous to have a comprehensive, automated system for broadcast information capture, which makes the information accessible for all data mining purposes.

### SUMMARY OF THE INVENTION

Accordingly, it is a principal object of the present invention to provide a comprehensive, automated system for broadcast information capture, which makes the information accessible for all data mining purposes.

It is another principal object of the present invention to provide analysis of all broadcast media, including audio and visual segments and all content of broadcast television for purposes of research and analysis.

It is one more principal object of the present invention to provide a data mining capability of all broadcast information, which includes all channels, simultaneously for some or all global, geographic areas.

It is one other principal object of the present invention to introduce the accountability and precision of the Internet to the realm of television content.

It is a further principal object of the present invention to eliminate use of digital coding, but rather to accurately trace content independently without allowing external intervention.

A system is disclosed to enable comprehensive capture of broadcast media information comprising video, audio and text content. The system includes a plurality of antennas to receive a plurality of channels in one location, a channel splitter to split the plurality of channels, a plurality of receivers, each to receive and decode either one channel or a group of channels simultaneously. The system also includes a storage network to archive the previously received broadcast media information content within the plurality of channels and a common Web browser to provide “on the spot” retrieving of airing statistics related to broadcast media information content, such that live analysis of the broadcast media information content of the plurality of channels is enabled.

Furthermore the system includes a plurality of real time content analyzers (RTCA's) to provide analysis of all broadcast media information, including audio and visual segments, for content information capture and storage, a traffic monitoring and control subsystem for both general monitoring and specific monitoring of said video, audio and text content, a storage network to archive previously received materials. Finally, the system includes a plurality of user query terminals to access one of all and a portion of said plurality of channels over one of all storage time periods and a portion of said storage time periods, at least one application server to manage and process said queries and a communications channel to provide high-speed, high bandwidth communication between said plurality of RTCA's, said storage network, said at least one application server and said plurality of user query terminals, such that live analysis of broadcast content and data-mining are enabled for said live content and said previously received materials.

The U.S. market, comprising approximately 900 channels simultaneously, will be described herein by way of example. The first step is information capture so as to receive all these channels in one location. In an exemplary embodiment there are antennas receiving signals from two principal satellites. These satellites cover all U.S. national and local channels. In a preferred embodiment there is some redundancy. The next step is performed by a splitter that will split all 900 channels simultaneously into separate signals.

The present invention offers a unique media-mining DMCR database and search engine to serve decision makers, corporations, advertisers, broadcasters, public figures, academic institutions and high-profile individuals to track broadcast television exposure across the U.S. and global markets.

The present invention has integrated a complex database-parsing technology using state-of-the-art broadcast captioning methods to trace content by text, voice, and image across the entire television and radio broadcast domain. Crucial airing or exposure questions are answerable immediately and accurately, through an easily accessible and secure Web-based interface. Because of this, the present invention provides online access to content parameter analysis and instant report generation. Important airing statistics will be retrievable “on the spot” through a common Web browser.

The heart of the system is a Real Time Content Analyzer (RTCA) to enable analysis of TV and radio content by text, audio and video. This architecture enables both live analysis of televised content and data-mining of previously stored materials.

Once content has been captured, recorded and organized, the resulting knowledge is made globally accessible to clients, allowing them to research what, when and where any content was broadcast on all channels across the U.S. and globally. Clients can carry out such research through a single Web database enabling “on the spot” search by text, audio and video.

Using the present invention services, private or public entities such as PR companies will be able to determine, with precise accuracy, the exact airing time, duration, frequency, channel(s), and placement of any content. For example, a political figure may want to examine the impact of a campaign by analyzing his exposure on local or national TV for a defined period after the ad campaign. Advertisers, and competitive analysts, will finally be able to gain access to accurate statistics about product placement commercials. Royalties' recipients, such as song authors/publishers/performers can track performances. The present invention has the independent capability to trace TV appearances with the utmost accuracy, allowing content providers to track exposures.

Tracing content by text, voice, and image, the present invention stores and updates a complete index of topics or subjects, such as TV personalities, historical figures, songs, sport teams and more. A complete set of broadcast parameters is indexed, to allow further analysis with advanced statistics. With this service, an individual can request a report on the number of times a subject appeared on TV during the past week, on which channels, for how long, and in which context. This information has never been available, in any form, before the present invention.

Hereinafter, the term “computer user” and “user” both refer to the person who operates the Web browser, or other GUI interface, and navigates through the system of the present invention by operating a computer.

Hereinafter, the term “computer” refers to a combination of a particular computer hardware system and a particular software operating system. Examples of such hardware systems include those with any type 10 of suitable data processor. Hereinafter, the term “computer” includes, but is not limited to, personal computers (PC) having an operating system such as DOS, Windows™, ^{OS/2}™ or Linux; Macintosh™ computers; computers having JAVA™-OS as the operating system; and graphical workstations such as the computers of Sun Microsystems™ and Silicon is Graphics™, and other computers having some version of the UNIX operating system such as AIX™ or SOLARIIS™ of Sun Microsystems™; a PalmPilot™, a PilotPC™ or any other handheld device, or any other known and available operating system. Hereinafter, the term Windows™ includes but is not limited to Windows95™, Windows 3.x™ in which “x” is an integer such as “1,” Windows NT™, Windows98™, Windows CET, WindowsXP™ or any upgraded version of these operating systems by Microsoft Corp. (USA).

For the present invention, a software application could be written in substantially any suitable programming language, which could easily be selected by one of ordinary skill in the art. The programming language chosen should be compatible with the computer by which the software application is executed, and in particularly with the operating system of that computer. Examples of suitable programming languages include, but are not limited to, C, C++ and Java. Furthermore, the functions of the present invention, when described as a series of steps for a method, could be implemented as a series of software instructions for operation by a data processor, such that the present invention could be implemented as software, firmware or hardware, or a combination thereof.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

FIG. 1 is a diagrammatic representation of the Data Mining Content Retrieval (DMCR) system configuration for comprehensive broadcast information capture and access, constructed according to the principles of the present invention;

FIG. 2 is a diagrammatic representation of the real time content analyzer (RTCA), constructed according to the principles of the present invention;

FIG. 3 is a general flow chart of an exemplary embodiment of the method for DMCR system configuration for comprehensive broadcast information capture and access, constructed according to the principles of the present invention;

FIG. 4 is a flow chart of the details of the query processing step of FIG. 3, constructed according to the principles of the present invention; and

FIG. 5 is a flow chart of a preferred embodiment of the data mining procedure of comprehensive broadcast information, constructed according to the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

The Real Time Content Analyzer (RTCA) subsystem analyzes all broadcast media, including audio and visual segments, for content information capture and storage. The query subsystem involves data mining of the information which across any or all of the approximately 900 US channels, for example, across materials, across geographic areas, etc.

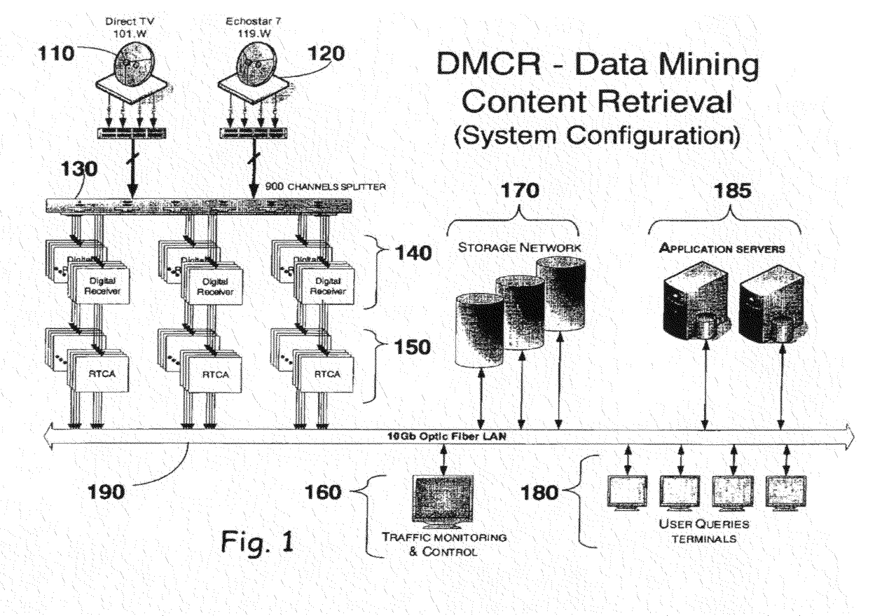

Reference is now made to FIG. 1, which is a diagrammatic representation of the Data Mining Content Retrieval (DMCR) system configuration 100 for comprehensive broadcast information capture and access, constructed according to the principles of the present invention.

For the U.S. market there are initially two (2) antennas 110 and 120. Antennas 110 and 120 can cover all the channels, including local stations. Of course, there is some redundancy. A splitter 130 splits the input signal into the approximately 900 separate channels. The individual signals are then fed to 900 corresponding receiver/decoders 140, and from each receiver/decoder 140 to a corresponding RTCA 150. RTCA's 150 are hosted in a special purpose computer.

From RTCA's 150 all the information that's been analyzed goes to the storage network 170 and to the traffic monitoring and control unit 160. Traffic monitoring and control unit 170 is a general monitor and then there are specific monitors for specific purposes, such as video, audio and text. Communication between RTCA 150 and storage network 170 is done, for example by a 10 GByte LAN fiber optic line 190.

Queries can be entered on user query terminals 180 and processed by the application servers 185 at any time. For example, a request may be received for those RTCA's 150 pertaining to Georgia. Thus all 900 channels need not be tied up for every query. On the other hand there may be another query, from President Bush's office, asking to determine his exposure all over the U.S. The requirement should be entered for all 900 channels simultaneously. In practice, one RTCA may be concentrated into one or many channels at the same time.

Once all the information is in one location of storage network 170, information can be accessed across all channels simultaneously, time periods and/or across geographic regions, etc. For example, if a song is sung on the radio, one can search across all channels in the U.S. for purposes of assigning royalty payments.

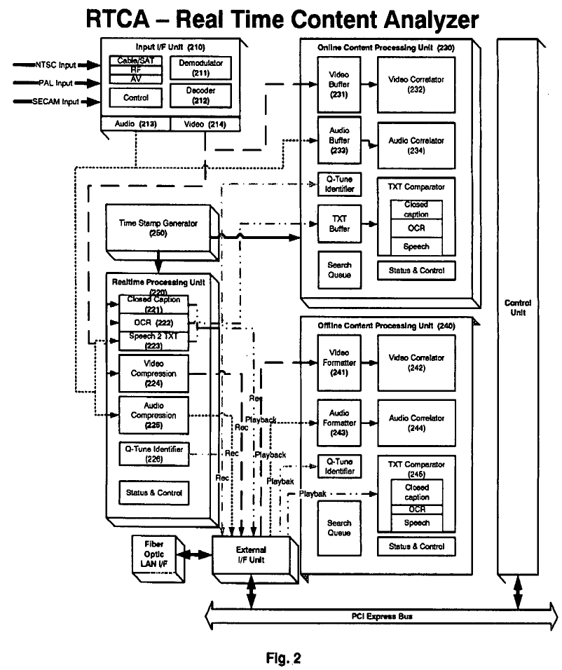

FIG. 2 is a diagrammatic representation of the real time content analyzer (RTCA) 150, constructed according to the principles of the present invention. RTCA 150 is four major units. The first unit is the input unit 210 comprising a demodulator 211, a decoder 212, a separated audio component 213 and a separated video component 214.

Separated audio component 213 and separated video component 214 are both sent to the Real Time processing unit 220 and the Online Content Processing unit 230. Real Time processing unit 220 processes with closed caption unit 221, optical character recognition (OCR) unit 222, speech-to-text unit 223, video compression unit 224, audio compression unit 225 and Q-Tone Identifier 226, which cues the positioning of an advertisement, for example. Real time and online information is marked by a Time Stamp Generator 250.

Closed caption signals are derived as follows. In T.V. broadcast signals comprise 500 lines. Line 21 is not visible, but rather it's an ASCII string. In real time the result is seen as a closed caption. Most broadcasters already comply with the federal requirement in the U.S. that everything, including talk shows, needs to make available closed caption. It's not accurate, because a professional person is transcribing the voices as best he can. But you get a very good idea of the conversation. E.g., if the words “George Bush” are mentioned, they will definitely appear in the closed caption.

For real time, the viewer uses the remote control, which by law has one option called “closed caption,” . . . off or on. If one puts it on, for example during a talk show, the transcription appears on the bottom of the screen.

In another aspect of audio processing, the audio signal is fed to speech-to-text processing unit 223, preferably for transcription by an automated processor. Thus, the audio can be cross checked for accuracy between closed caption unit 221 and speech-to-text unit 223. Furthermore the Audio unit 234 could identify independent audio such as speech or music.

OCR unit 222 is used, for example, because a billboard may appear on the screen. The text is captured by OCR unit 222.

Online Content Processing unit 230 does real time analysis of the audio in an audio buffer 231 and an audio correlator 232, analysis of the video in a video buffer 233 and a video correlator 234, as is, i.e., without compression and analysis of all forms text in a text buffer 235 and text comparator 236.

Offline Content Processing unit 240 does (frequently vast) archival analysis. This includes analysis of the audio in an audio buffer 241 and an audio correlator 242, analysis of the video in a video buffer 243 and a video correlator 244, as is, i.e., without compression and analysis of all forms of text in a text comparator 245. Archived data has already been time stamped.

The controller for a very fast fiber optic LAN 250 is able to provide transfer of up to 10 Gb/s compressed data.

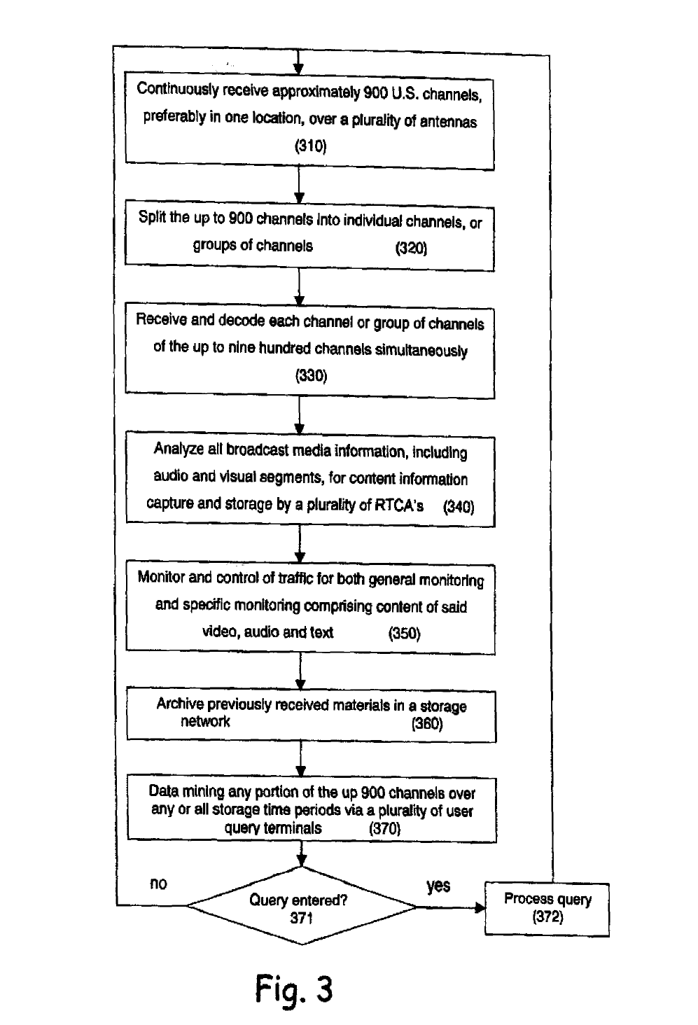

FIG. 3 is a general flow chart of an exemplary embodiment of the method for DMCR system configuration for comprehensive broadcast information capture and access, constructed according to the principles of the present invention. First, the system continuously receives approximately 900 U.S. channels, preferably in one location, over a plurality of antennas 310. Then the up to 900 channels are split into individual channels, or groups of channels 320. Subsequently, each channel or group of channels of the up to nine hundred channels are received and decoded simultaneously 330.

Then all of the broadcast media information is analyzed, including audio and visual segments, for content information capture and storage by a plurality of RTCA's 340. Monitoring and control of traffic for both general monitoring and specific monitoring comprising content of the video, audio and text are performed 350. All previously received materials are archived in a storage network 360. Finally, user query terminals are used for data mining purposes to access any portion of the channels over any storage time period or periods 370. From time to time queries are entered 371 and processed 372.

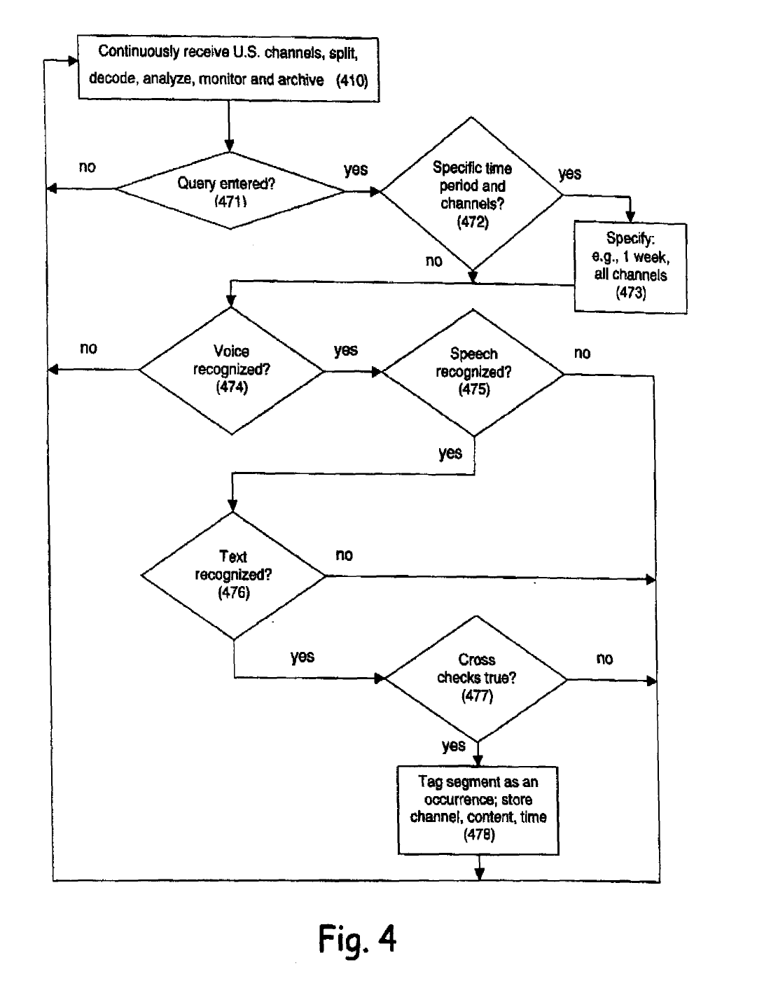

FIG. 4 is a flow chart of the details of the query processing step of FIG. 3, constructed according to the principles of the present invention. In general, broadcast information is continuously received over all U.S. channels 410. This information is then split, decoded, analyzed, monitored, controlled and archived, as detailed in the flowchart of FIG. 3.

The following scenario illustrates data mining, according to the principles of the present invention. A political advisor may want to monitor the impact of a speech on environmental policy made by the U.S. president. The speech may have been made a week ago and may have made specific reference to the Kyoto protocols. If such a query has been entered 471 and the exemplary time period of one week and coverage for all channels has been entered 472, 473, the content stored over the last week is checked over all channels for voice recognition of the President's voice, and when the voice is recognized 474, either on radio or television, the content is checked for speech recognition of the phrase “Kyoto protocols” 475. A text check 476 is also made on the closed caption text. Cross checks are then made 477 between the voice and text results. When all checks are positive the segment is tagged as an occurrence, and the channel, content, context and occurrence time and duration are stored 478.

Such data mining serves decision makers, corporations, advertisers, broadcasters, those collecting royalties, public figures, academic institutions and high-profile individuals to track broadcast television exposure across the U.S. and global markets. The present invention has the independent capability to easily trace TV and radio appearances with the utmost accuracy, allowing content providers to track exposures in a user friendly, spontaneous and seamless framework.

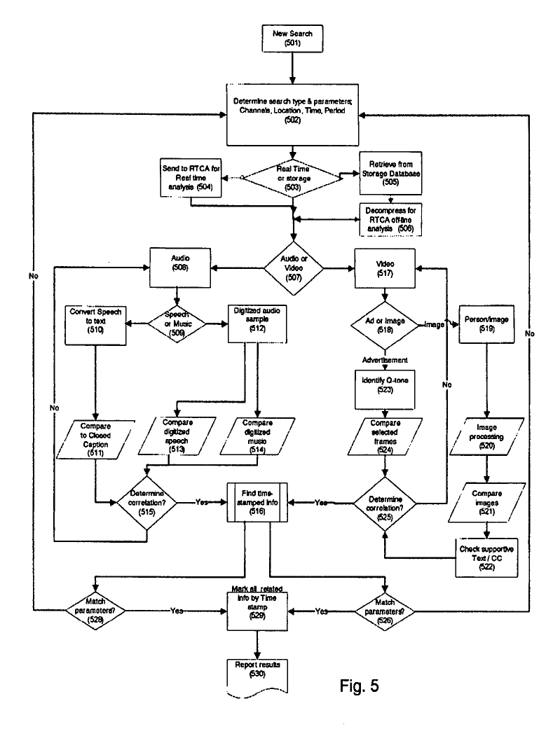

FIG. 5 is a flow chart of a preferred embodiment of the data mining procedure of comprehensive broadcast information, constructed according to the principles of the present invention. When a new search is initiated 501, the search type and parameters are determined: channels, location, time and period 502. The search type can be in real time or based on stored information 503. For a real time search the query is sent to the RTCA for real time analysis 504. If the search is based on stored information, the information is retrieved from a storage database 505 and is decompressed for RTCA offline analysis 5-6.

It is then determined whether the query is for audio or video or both 507. If at least for audio 508, it is determined whether the query is for speech or music or both 509. If at least for speech the information is converted from speech to text 510 and is then compared to the stored closed caption (CC) information 511. If the query is at least for music a digitized audio sample 512 is compared to digitized speech 513 and compared to digitized music 514. If there is a correlation 515, the time stamped information is located 516. If the parameters match 528 then all related information is marked by a time stamp 529 and the results are reported 530.

If at least for video 517 it is determined whether the query is for an advertisement or an image or both 518. If the query is at least for a person or other image 519, the image is processed 520 and then is compared to images 521 and checked for any supportive text or CC information 522. If there is a correlation 525, the time stamped information is located 516. If the parameters match 526 then all related information is marked by a time stamp 529 and the results are reported 530.

If the query is at least for an advertisement the Q-tone is identified 523 and then is compared to selected frames 524. If there is a correlation 525, the time stamped information is located 516. If the parameters match 526 then all related information is marked by a time stamp 529 and the results are reported 530.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A system to enable comprehensive capture of broadcast media information comprising video, audio and text content, said system comprising:
a plurality of antennas to receive a plurality of channels in one location;
a channel splitter to split said plurality of channels;
a plurality of receivers, each to receive and decode said one of individual channels and groups of channels simultaneously;
a storage network to archive the previously received broadcast media information content within said plurality of channels; and
a common Web browser to provide “on the spot” retrieving of airing statistics related to broadcast media information content,
such that live analysis of said broadcast media information content of said plurality of channels is enabled.

2. The system of claim 1, further comprising a plurality of real time content analyzers (RTCA's) to provide analysis of all of the broadcast media information, including audio and visual segments, for content information capture and storage.

3. The system of claim 2, further comprising a traffic monitoring and control subsystem for monitoring of said video, audio and text content.

4. The system of claim 3, further comprising a plurality of user query terminals to enable queries by users regarding content of the broadcast media information within said plurality of channels for all data mining purposes.

5. The system of claim 4, further comprising at least one application server to manage and process said queries.

6. The system of claim 5, further comprising a communications channel to provide high-speed, high bandwidth communication between said plurality of RTCA's, said storage network, said at least one application server and said plurality of user query terminals.

7. The system of claim 4, wherein said plurality of user query terminals access all of said plurality of channels.

8. The system of claim 4, wherein said plurality of user query terminals access a portion of said plurality of channels.

9. The system of claim 4, wherein said plurality of user query terminals access said plurality of channels over at least one specific time period.

10. The system of claim 9, wherein said at least one specific time period is unlimited.

11. The system of claim 6, wherein said traffic monitoring is general monitoring.

12. The system of claim 6, wherein said traffic monitoring is specific monitoring.

13. The system of claim 6, wherein said channel splitter splits said plurality of channels into individual channels simultaneously.

14. The system of claim 6, wherein said channel splitter splits said plurality of channels into groups of channels simultaneously.

15. The system of claim 6, wherein said data mining is enabled globally.

16. The system of claim 6, wherein said data mining is enabled for at least one specific geographic area.

17. A comprehensive method to provide capture of broadcast media information comprising video, audio and text content, said method comprising:
continuously receiving a plurality of broadcast channels in one location, over a plurality of antennas;
splitting said plurality of channels;
receiving and decoding by a plurality of receivers, each to receive and decode said one of individual channels and groups of channels simultaneously;
analyzing all of said broadcast media information, including audio and visual segments, for content information capture and storage by a plurality of RTCA's;
monitoring and controlling of traffic for content of said video, audio and text; and
archiving previously received materials in a storage network,
such that live analysis of broadcast content is enabled.

18. The method of claim 17, further comprising data mining said plurality of channels via a plurality of user query terminals,
such that live analysis of broadcast content and data-mining are enabled.

19. The method of claim 18, wherein said plurality of user query terminals access all of said plurality of channels.

20. The method of claim 18, wherein said plurality of user query terminals access a portion of said plurality of channels.

21. The method of claim 17, wherein said plurality of user query terminals access said plurality of channels over at least one specific time period.

22. The method of claim 21, wherein said at least one specific time period is all time.

23. The method of claim 17, wherein said traffic monitoring and controlling is general monitoring.

24. The method of claim 17, wherein said traffic monitoring and controlling is specific monitoring.

25. The method of claim 17, wherein said splitting of said plurality of channels is into individual channels simultaneously.

26. The method of claim 17, wherein said splitting of said plurality of channels is into groups of channels simultaneously.

27. The method of claim 18, wherein said data mining is enabled globally.

28. The method of claim 18, wherein said data mining is enabled for at least one specific geographic area.

29. The method of claim 18, wherein said live analysis of broadcast content and data-mining are enabled for live content.

30. The method of claim 18, wherein said live analysis of broadcast content and data-mining are enabled for archived materials.

31. The method of claim 17, wherein said analyzing is done online.

32. The method of claim 17, wherein said analyzing is done electronically.

33. The method of claim 17, wherein said analyzing is done manually.

34. The method of claim 17, wherein said analyzing is done by software means.

35. The method of claim 17, wherein said analyzing is done by hardware means.

36. The method of claim 17, wherein said analyzing is done by a combination of software and hardware means.

37. The method of claim 17, wherein said analyzing is done by any combination of software, hardware, electronic or manually.
